(19) United States
(12) Patent Application Publication
(10) Pub. No.: US 2006/0286927 A1
(43) Pub. Date: Dec. 21, 2006

(54) Hybrid power line communications digital broadcast system

(76) Inventor: William H. Berkman, New York, NY (US)

Correspondence Address: CAPITAL LEGAL GROUP, LLC, 5323 POOKS HILL ROAD, BETHESDA, MD, 20814, US

(21) Appl. No.: 11/156,613

(22) Filed: Jun. 21, 2005

(51) Int. Cl. H04H 1/00

(52) U.S. Cl. 455/3.02; 375/257

(57) ABSTRACT

A hybrid power line communication systems (PLCS) and method for satellite broadcast communications and power line communications is provided. In one example embodiment, a broadcast receiver and antenna may be coupled to, or integrated with, a transformer bypass device that is coupled to both a low voltage and a medium voltage power line. The bypass device may further include a first modem configured to be connected to the LV power line subnet to provide communication services to multiple customer premises and a router for routing data from either the medium voltage power line or the receiver to the first modem for transmission to one or more user devices.

### FIELD OF THE INVENTION

The present invention generally relates to data communications over a power distribution system and more particularly, to a system and method for delivering broadcast data services via a power line communications system.

### BACKGROUND OF THE INVENTION

Well-established power distribution systems exist throughout most of the United States, and other countries, which provide power to customers via power lines. With some modification, the infrastructure of the existing power distribution systems can be used to provide data communication in addition to power delivery, thereby forming a power line communication system (PLCS). In other words, existing power lines that already have been run to many homes and offices can be used to carry data signals to and from the homes and offices. These data signals are communicated on and off the power lines at various points in the power line communication system, such as, for example, near homes, offices, Internet service providers, and the like.

Power distribution systems include numerous sections, which transmit power at different voltages. The transition from one section to another typically is accomplished with a transformer. The sections of the power distribution system that are connected to the customers premises typically are low voltage (LV) sections having a voltage between 100 volts(V) and 1,000V, depending on the system. In the United States, the LV section typically is about 120V. The sections of the power distribution system that provide the power to the LV sections are referred to as the medium voltage (MV) sections. The voltage of the MV section is in the range of 1,000V to 100,000V. The transition from the MV section to the LV section of the power distribution system typically is accomplished with a distribution transformer, which converts the higher voltage of the MV section to the lower voltage of the LV section.

Power system transformers are one obstacle to using power distribution lines for data communication. Transformers act as a low-pass filter, passing the low frequency power signals (e.g., the 50 or 60 Hz) and impeding the high frequency signals (e.g., frequencies typically used for data communication). As such, power line communication systems face the challenge of communicating the data signals around, or through, the distribution transformers. Thus, many power line communications systems include a transformer bypass device (BD), which may act as the gateway between the MV and LV power lines. In many PLCSs, the user devices of numerous customers communicate with a single BD over the same LV power line subnet.

Terrestrial transmitters located at a terrestrial broadcasting location for transmitting converted local channel signals to satellite dishes are common. Satellite services, such as direct broadcast satellite (DBS) and digital audio radio satellite (DARS) services, are relatively recent developments in entertainment distribution. Typically, these systems have the disadvantage of requiring separate coaxial cables to deliver the signals to home entertainment devices, such as a television. Furthermore, many currently used DBS and DARS receivers need to be connected to a telephone line in order to communicate with the satellite entertainment provider. Such communications may involve pay per movie selections and information about payment.

Multifamily dwellings, condominiums and communities in which satellite dishes coupled to, or adjacent to, single family dwellings are forbidden are increasingly common. Under such circumstances where a single collective dish might be possible, the business or residential area often needs to have coaxial cable and telephone lines installed to the areas where the entertainment services are desired. This can be both inconvenient and expensive.

Thus, there is a need for a system and method that provides the distribution of broadcast entertainment services and power line communications. These and other advantages may be provided by various embodiments of the present invention.

### SUMMARY OF THE INVENTION

The present invention provides for hybrid power line communication systems (PLCS) and method that provides satellite broadcast communications and power line communications. In one example embodiment, a broadcast receiver and antenna may be coupled to, or integrated with, a transformer bypass device that is coupled to both a low voltage and a medium voltage power line. The bypass device may include a first modem configured to be connected to the LV power line subnet to provide communication services to multiple customer premises.

The satellite antenna is of a conventional variety, well known in the art, which may accept either satellite and/or terrestrial signals. Both satellite radio antenna and satellite dish antenna for receipt of video and/or audio satellite signals are contemplated by the present invention.

In operation, the bypass device may transmit the digital data to the user devices via the LV power lines. Alternatively, the digital broadcast data may be transmitted to the user devices via a wireless link, coax cable, or other medium. The customer premises will include have a modem suitable for receiving the data, such as a power line modem for LV power line transmissions, a wireless modem, or a conventional satellite or cable receiver.

The user may also have a control device (optimally with remote control capability) connected to a power line modem that may transmit requests for a particular channel to the bypass device.

The bypass device may also receive and take actions in response to commands received via the medium voltage (MV) power lines. For example, the bypass device may receive a command to enable or disable satellite television or radio subscription services. The bypass device may then discontinue transmitting the broadcast data to that control device or transmit that command to the proper control device. In addition, the bypass device may receive a command to buy a pay per view programming from the user. In response, the bypass device may cause the receiver to extract the selected programming data stream and transmit the data to the user's control device. In addition, the bypass device may transmit a notification of the purchase upstream, through either the MV power line or the satellite dish where possible, indicating the user's purchase of the program, which permits the broadcast provider to invoice the user.

An aspect of some embodiments of the present invention is to eliminate the need for a telephone line or other secondary communication so that any of the data conventionally sent via a telephone line can be sent by the BD over the MV power line.

Another aspect of some embodiments of the present invention is to provide satellite broadcast services to homes and businesses over the LV power lines so as to eliminate the need to use special wiring for that purpose.

Yet another aspect of some embodiments of the present invention is to provide satellite broadcast services to communities in which individual and conventional collective satellite dishes are impractical or forbidden.

These and other aspects of the present invention will become readily apparent upon further review of the following drawings and the specification.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a diagram of a prior art satellite broadcast system and an exemplary power distribution system;

FIG. 2 is a diagram of a portion of an example hybrid power line communications digital broadcast system, in accordance with an example embodiment of the present invention

FIG. 3 is a block diagram of a bypass device, in accordance with an example embodiment of the present invention; and

FIG. 4 is another block diagram of a bypass device, in accordance with an example embodiment of the present invention.

### DETAILED DESCRIPTION OF ILLUSTRATIVE EMBODIMENTS

In the following description, for purposes of explanation and not limitation, specific details are set forth, which may include, for example, particular networks, communication systems, computers, terminals, devices, PLCSs, receivers, tuners, antennas, components, techniques, data and network protocols, software products and systems, operating systems, development interfaces, hardware, and the like in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, PLCSs, receivers, tuners, antennas, components, techniques, data and network protocols, software products and systems, operating systems, development interfaces, hardware and the like are omitted so as not to obscure the description of the present invention.

The term “broadcast data” is used herein to encompass any form of terrestrial and satellite broadcast services, including but not limited to DBS and DARS. Examples of service providers include EchoStar™, Gilat Satellite Networks™, DirecTV (Hughes)™, News Corporation™, Primestar™, and USSB (United States Satellite Broadcasting)™, XM Radio™, and Sirius™. The present invention will be primarily described in terms of a DBS but it is understood to include other satellite communication services, as well. Specifically, the present invention includes satellite communication services in which data communication signals are up linked and down linked. In addition, digital wireless broadcasts may further include digital high definition television (HDTV) signals and other digital signals broadcasts by local stations, which may be terrestrial broadcasts.

System Architecture and General Design Concepts

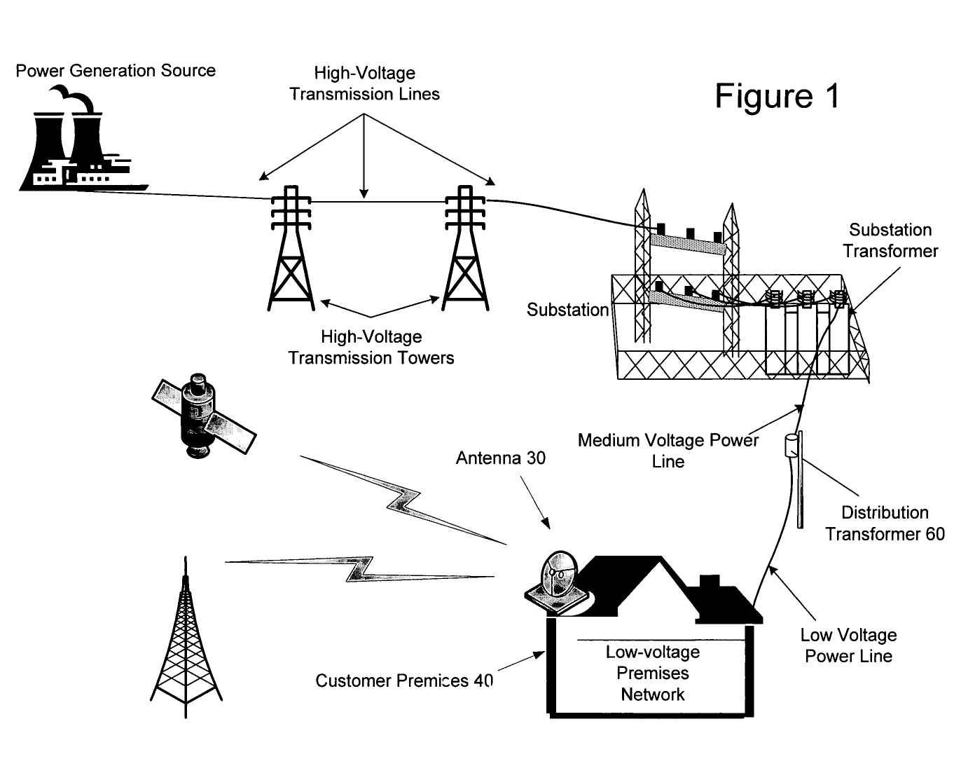

As shown in FIG. 1, power distribution systems typically include components for power generation, power transmission, and power delivery. A transmission substation typically is used to increase the voltage from the power generation source to high voltage (HV) levels for long distance transmission on HV transmission lines to a substation. Typical voltages found on HV transmission lines range from 69 kilovolts (kV) to in excess of 800 kV.

In addition to HV transmission lines, power distribution systems include MV power lines and LV power lines. As discussed, MV typically ranges from about 1000 V to about 100 kV and LV typically ranges from about 100 V to about 1,000 V. Transformers are used to convert between the respective voltage portions, e.g., between the HV section and the MV section and between the MV section and the LV section. Transformers have a primary side for connection to a first voltage (e.g., the MV section) and a secondary side for outputting another (usually lower) voltage (e.g., the LV section). Such transformers are often referred to as distribution transformers or as step down transformers, because they “step down” the voltage to some lower voltage. Transformers, therefore, provide voltage conversion for the power distribution system. Thus, power is carried from substation transformer to a distribution transformer over one or more MV power lines. Power is carried from the distribution transformer to the customer premises via one or more LV power lines.

In addition, a distribution transformer may function to distribute one, two, three, or more phase voltages to the customer premises, depending upon the demands of the user. In the United States, for example, these local distribution transformers typically feed anywhere from one to ten homes, depending upon the concentration of the customer premises in a particular area. Distribution transformers may be pole-top transformers located on a utility pole, pad-mounted transformers located on the ground, or transformers located under ground level.

A conventional digital broadcast reception arrangement is also shown in FIG. 1. The antenna 30, most frequently a parabolic satellite dish, is used to collect signals from one or more satellites in a geostationary orbit and to reflect them to a feed horn that receives them and provides the signals to a low noise blockdown (LNB) converter to be amplified and transmitted to a the receiver.

The receiver (not shown) is the part of the reception equipment and may have a tuner to tune to a single program channel broadcast from a satellite. A decoder unit (or chip) is incorporated into a satellite receiver to unscramble the signal that is protected by encryption. The receiver processes the signal and passes it to a standard television or other customer presentation device. The conventional receiver is typically found at the customers premises 40. As discussed, the antenna 30 may also receive satellite broadcast signals from terrestrial origins, frequently to receive local programming. A large variety of satellite broadcast reception systems and methods are well known in the art and, therefore, not repeated in detail here.

Hybrid Power Line Communications Digital Broadcast System

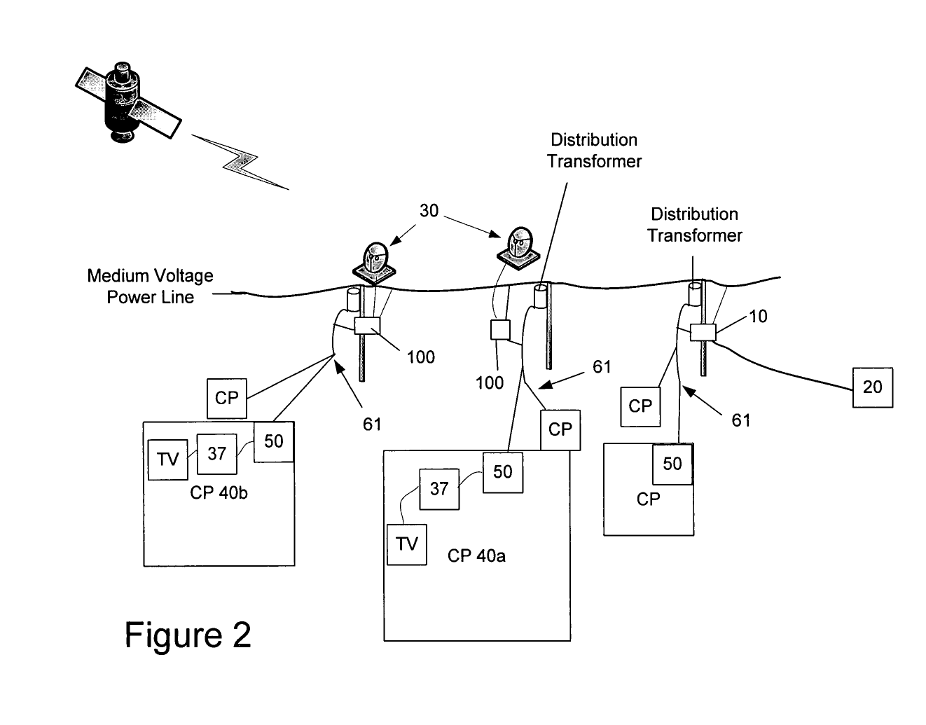

One example of a portion of such a hybrid PLC digital broadcast system is shown in FIG. 2 and includes a power line communications device, which may be a bypass devices 100 that is configured to provide digital broadcast data and power line communication data to the user devices that are communicatively coupled to the LV subnet of the bypass device 100. The BD 100 communicates power line communication data signals around the distribution transformer that would otherwise filter such data signals, preventing them from passing through the transformer or significantly degrading them. Thus, the BD 100 is the gateway between the LV power line subnet (i.e., the devices that are communicatively coupled to the LV power lines), and the MV power line. In the present example embodiment, the BD 100 communicates signals to and from user devices at the customer premises (CP) via the low voltage subnet 61. In addition, the bypass device 100 may provide digital broadcast data (e.g., such as DBS, DARS, and/or a terrestrial broadcast antenna—any of which may include high definition television (HDTV) programming) to the user devices coupled to the LV subnet. Thus, the customer premises (such as CP 40a) may include a power line modem 50 for communicating via the LV power line.

In this embodiment, the BD 100 may provide communication services for the user, which may include security management, routing of Internet Protocol (IP) packets, filtering data, access control, service level monitoring, signal processing and modulation/demodulation of signals transmitted over the power lines. Furthermore, the BD 100 may provide communication between the broadcast provider and the customer.

This example portion of the present invention also includes a backhaul point 10. The backhaul point 10 is an interface and gateway between a portion of a PLCS (e.g., a PLC subnet) and a traditional non-power line telecommunications network. One or more backhaul points (BP) 10 may be communicatively coupled to an aggregation point (AP) 20 that in many embodiments may be at (e.g., co-located with), or connected to, the point of presence to the Internet. The BP 10 may be connected to the AP 20 using any available mechanism, including fiber optic conductors, T-carrier, Synchronous Optical Network (SONET), or wireless techniques well known to those skilled in the art. Thus, the BP 10 may include a transceiver suited for communicating through the communication medium.

The AP 20 may include a conventional Internet Protocol (IP) data packet router and may be directly connected to an Internet backbone thereby providing access to the Internet. Alternatively, the AP 20 may be connected to a core router (not shown), which provides access to the Internet, or other communication network. Depending on the configuration of the PLCS, a plurality of APs 20 may be connected to a single core router which provides Internet access. The core router (or AP 20 as the case may be) may route voice traffic to and from a voice service provider and route Internet traffic to and from an Internet service provider and/or video provider. Signals directed to the broadcast provider may be routed with the voice traffic or with internet traffic, as desired. The routing of packets to the appropriate provider may be determined by any suitable means such as by including information in the data packets to determine whether a packet is voice or destined for voice routing. If the packet is voice, the packet may be routed to the voice service provider and, if not, the packet may be routed to the Internet service provider. Similarly, the packet may include information (which may be a portion of the address) to determine whether a packet is Internet data. If the packet is Internet data, the packet may be routed to the Internet service provider and, if not, the packet may be routed to the voice service provider. Additionally, if the packet includes voice, video or other time sensitive data, it may be accorded a higher priority to thereby reduce the latency thereof.

The PLCS also may include a power line server (PLS) that is a computer system with memory for storing a database of information about the PLCS and includes a network element manager (NEM) that monitors and controls the PLCS. The PLS allows network operations personnel to provision users and network equipment, manage customer data, and monitor system status, performance and usage. The PLS may reside at a remote network operations center (NOC), and/or at a PLCS Point of Presence (POP), to oversee a group of communication devices via the Internet. The PLS may provide an Internet identity to the network devices by assigning the devices (e.g., user devices, BDs 100, (e.g., the LV modems and MV modems of BDs), broadcast signal receivers, BPs 10, and AP 20) IP addresses and storing the IP addresses and other device identifying information (e.g., the device's location, address, serial number, etc.) in its memory. In addition, the PLS may approve or deny user devices authorization requests, command status reports, statistics and measurements from the BDs, and BPs, and provide application software upgrades to the communication devices (e.g., BDs, BPs, and other devices). The PLS, by collecting electric power distribution information and interfacing with utilities' back-end computer systems may provide enhanced power distribution services such as automated meter reading, outage detection, restoration detection, load balancing, distribution automation, Volt/Volt-Amp Reactance (Volt/VAr) management, and other similar functions. The PLS also may be connected to one or more APs and/or core routers directly or through the Internet and therefore can communicate with any of the BDs, user devices, and BPs through the respective AP and/or core router. The PLS may also be able to communicate with the broadcast signal receivers, associated devices, control devices, broadcast provider, and/or broadcast related user devices.

The PLCS may further include indoor low voltage repeaters and outdoor low voltage repeaters. Indoor low voltage repeaters may be plugged into a wall socket inside the customer premises. Outdoor low voltage repeaters may be coupled to the external low voltage power line conductors extending from the transformer and therefore, be located between the customer premises and the BD 100. Both the indoor low voltage repeaters and outdoor low voltage repeaters repeat data, which may include satellite broadcast signals, on the low voltage power line to extend the communication range of the BD 100, or power line modem 50.

At the user end of the PLCS of this example system, data flow originates from a user device, which provides the data to a power line modem (PLM) 50, which is well-known in the art. Various electrical circuits within the customer's premises distribute LV power and data signals within the customer premises. The customer draws power on demand by plugging a device into a power outlet. In a similar manner, the customer may plug the PLM 50 into a power outlet to digitally connect user devices to communicate data signals carried by the LV wiring. The PLM 50 thus serves as an interface for user devices to access the PLCS. The PLM 50 can have a variety of interfaces for customer data appliances. For example, a PLM 50 can include a RJ-11 Plain Old Telephone Service (POTS) connector, an RS-232 connector, a coaxial cable connector, a digital video interface, a USB connector, a Ethernet 10 Base-T connector, RJ-45 connector, and the like. In this manner, a customer can connect a variety of user devices to the PLCS. Further, multiple PLMs can be plugged into power outlets throughout the customer premises, with each PLM 50 communicating over the same wiring internal of the customer premises to the BD 100.

The user device connected to the PLM 50 may be any device capable of supplying data for transmission (or for receiving such data) including, but not limited to a computer, a telephone, a telephone answering machine, a fax, a digital cable box (e.g., for processing digital audio and video, which may then be supplied to a conventional television and for transmitting requests for video programming), a video game, a stereo, a videophone, a television (which may be a digital television), a video recording device (which may be a digital video recorder), a home network device, a utility meter, or other device. The PLM 50 transmits the data received from the user device through the LV power lines to a BD 100 and provides data received from the LV power line to the user device. The PLM 50 may also be integrated with the user device, which may be a computer. In addition, the functions of the PLM 50 may be integrated into a smart utility meter such as a gas meter, electric meter, water meter, or other utility meter to thereby provide automated meter reading (AMR).

The BD 100 typically transmits the data to (and receives the data from) the backhaul point 10, which, in turn, transmits the data to (and receives the data from) the AP 20. The AP 20 then transmits the data to (and receives the data from) the appropriate destination (perhaps via a core router), which may be a network destination (such as an Internet address) in which case the packets are transmitted to, and pass through, numerous routers (herein routers are meant to include both network routers and switches) in order to arrive at the desired destination.

The PLS also may store the hierarchical configuration of the BP 10 and BDs 100 for each MV run in the network in its memory (or database) to help facilitate and maintain the desired route configuration. This hierarchy information may include address and other information.

The embodiment described below includes a BD 100 that operates as BD 100 for bypassing a pole-mounted transformer. The present invention may be equally applicable for use in other power line communications devices, including other bypass devices for other types of transformers (such as pad mount or underground). In this or any embodiment, the BD 100 may provide a path for data to bypass the transformer by being coupled to the same MV power line conductor to which the transformer is coupled or to a different MV power line conductor and, in either instance, may be coupled to the same LV power lines to which the bypassed transformer is coupled. In addition, the BDs 100 may or may not be physically coupled to the same power line conductor to which the BP 10 is physically connected. For example, in overhead PLCS, high frequency data signals may cross-couple between the power line conductors.

In a first example embodiment shown in FIG. 2, the BD 100 may include a receiver portion and transmit selected programming to the customer premises according to selections from users. In this example embodiment, the CP (such as CP 40b) may include a control device 37 (which itself may be operated via a wireless remote control) that transmits a user request through PLM 50 to the BD 100, such as, for example, a request for a particular television, audio program, or a request to purchase a pay per view program. In response, the BD 100 may transmit the request to the receiver or cause the receiver to tune to the selected program data. Additionally, the BD 100 may transmit information via the MV power line or via an alternate method (e.g., wirelessly via an IEEE 802.11 link or via a satellite uplink) to the broadcast service provider (e.g., in the instance in which the user has selected a pay per view program).

Thus, in this embodiment the receiver of the BD 100 may include multiple tuners integrated therein (or co-located therewith) to allow multiple users connected to the LV subnet 61 to select different programming. As is known in the art, multiple tuners may require routing of the selected programming to the appropriate control devices 37 of the customer premises by the BD 100. Thus, the control devices 37 of this embodiment may be addressable by the BD 100 (or PLS) and/or have a unique address. Also, each CP 40 may have multiple control devices therein to allow a single household to receive multiple programs. In addition, if a customer premises that receives the broadcast data also receives PLCS data (e.g., for communicating voice, internet, or other data), the PLM 50 may be replaced by a router and PLM 50 to allow routing of the data to and from the appropriate user device (e.g., television/control device 37 or computer). Broadcast data received by the PLN may routed directly to a compatible presentation device (e.g., a computer or a HDTV ready television) or may be provided to the control device 37, which may format the digital data into the appropriate format (e.g., NTSC or PAL) to be provided to the presentation device.

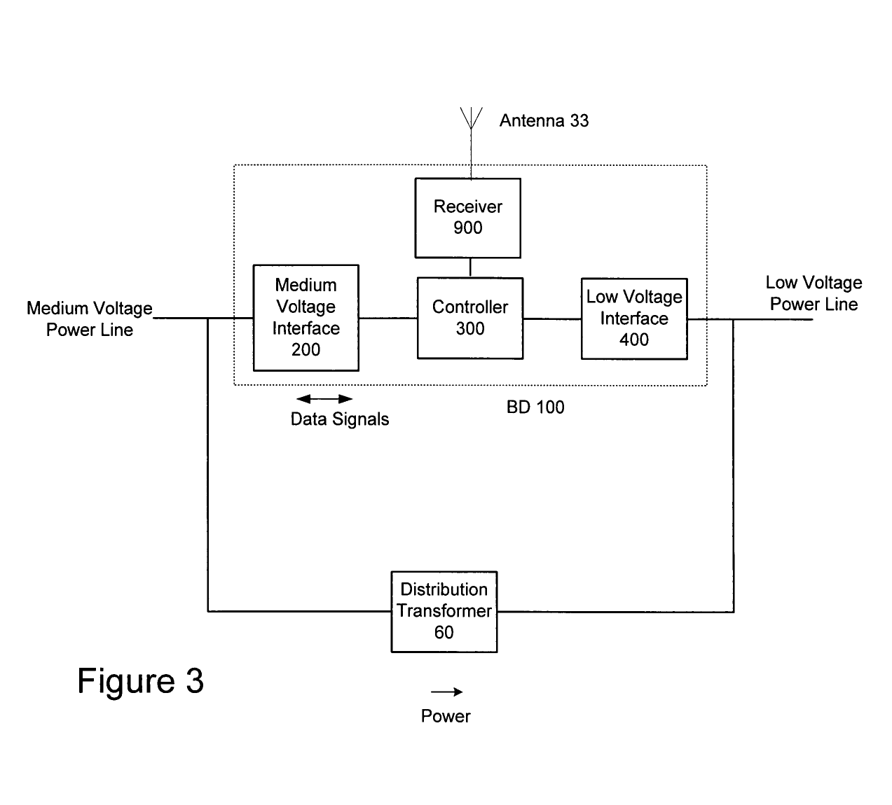

FIG. 3 provides an example embodiment of a BD 100 for implementing the present invention. This embodiment of the BD 100 includes a MV power line interface (MVI) 200, a controller 300, a LV power line interface (LVI) 400, a broadcast receiver 900, and an antenna 33. The BD 100 is controlled by a programmable processor and associated peripheral circuitry, which form part of the controller 300. The controller 300 includes memory that stores, among other things, routing information and program code for routing data and controlling the operation of the processor. The receiver 900 may be integrated into the BD and be enclosed in the same housing as the controller 300 or may separately housed.

For upstream communications, the PLM 50 communicates data to the bypass device 100, which may transmit the data upstream to the backhaul point 10 to the AP 20 and the internet. For downstream communications, PLC data (e.g., data from the internet) may travel from the AP 20, to the BP 10, to the BD 100, to the PLM 50, to the user device. For broadcast data, antenna 30 receives the signal from the satellite (or multiple satellites or terrestrial broadcast antenna) and provides the signal to the receiver 900 (e.g., via a LNB). The receiver 900 demodulates, decodes, decrypts, and may further processes the signal as is known if the art. Based on commands or tuning data supplied by the controller 300, the receiver 900 may provide the data for one or more broadcast programs to the controller 300 (i.e., the receiver 900 tunes to the selected programming). The controller routes the broadcast data (and downstream power line communication data from the MV power line) to the LVI 400 for transmission onto the LV subnet and reception by one or more PLMs 50, which may provide the broadcast data to the control device 37 or presentation device if appropriate. In an alternate embodiment, controller 300 may provide tuning by routing only the selected data streams to the LVI 400.

The receiver 900 may perform a number of separate tasks. First, the receiver 900 may de-scramble the encrypted signal. In order to decode the data, the receiver 900 may require the proper decoder chip or information for that programming package. In one embodiment, the broadcast service provider may communicate with the chip, via a broadcast signal or through the power line communication system, to make necessary adjustments to its decoding programs. In addition, the provider may occasionally send signals that disrupt illegal de-scramblers, as an electronic counter measure (ECM) against illegal users. Second, the receiver 900 may provide tuning by extracting the individual programming from the larger broadcast data stream. When the customer changes the programming, the receiver 900 typically selects just the data stream for the selected program. Consequently, an embodiment of the present invention may include a receiver 900 configured to provide tuning for multiple programming (i.e., having multiple tuner modules to extract multiple programming data streams to be supplied to controller 300).

The example BD 100 of the present invention may also store the selection and/or reception of pay-per-view programs and periodically transmit (e.g., via the PLCS) the stored data (along with information sufficient to identify the user) to the broadcast provider's computer to thereby communicate billing information. Furthermore, the receiver 900 may also perform other conventional functions as well. For example, the receiver 900 may receive programming schedule data (e.g., program guide information) from the broadcast provider, which may be transmitted by the BD 100 to all the control devices 37 of the broadcast service subscribers on the LV subnet. This information may then be stored in the control devices 37 for presentation to the user. Many receivers have parental lock-out options, which may also be incorporated into the control device 37 or BD 100. In addition, the control device 37 may also include a digital video recorder (DVR) integrated therein or connected thereto. As discussed above, in this example embodiment the control device 37 may process the digital MPEG-2 signal and convert the data into an analog or other format that a television or other device can process. In the United States, the data may be converted signal to the analog NTSC format. In some embodiments, the receiver 900 of BD 100 may provide an HDTV signal, which may not need conversion if the presentation device can process an HDTV signal (e.g., an HDTV ready television).

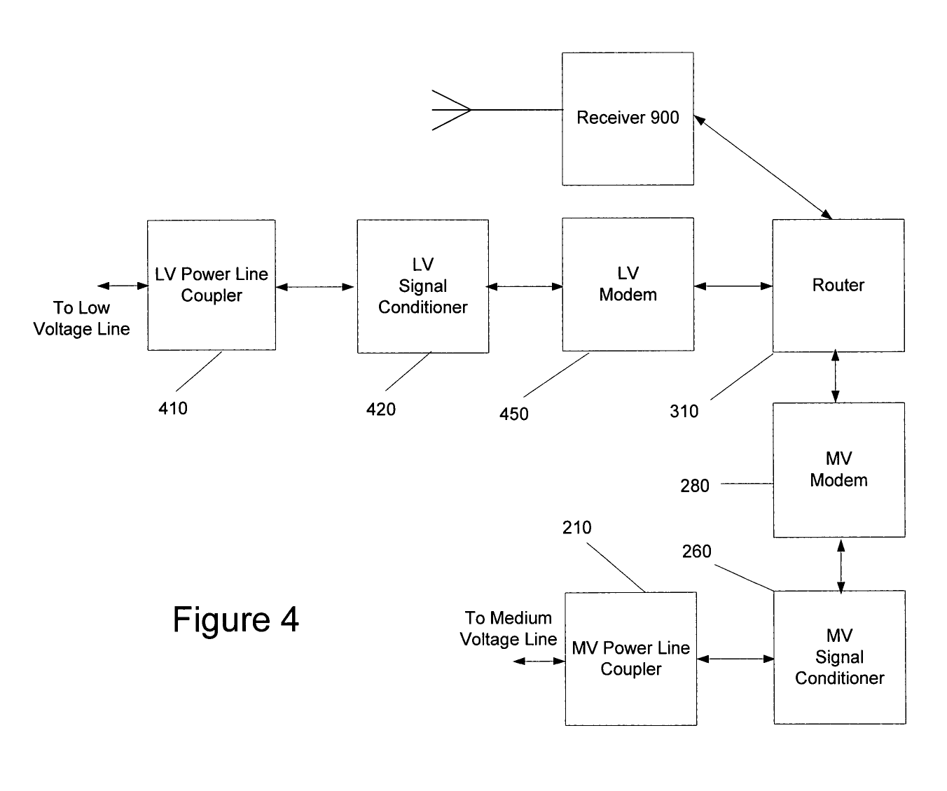

Referring to FIG. 4, the low voltage interface (LVI) 400 may include a LV power line coupler 410, a LV signal conditioner 420, and a LV modem 450. The router 310 forms part of the controller 300 and performs routing functions. Router 310 may perform routing functions using layer 3 data (e.g., IP addresses), layer 2 data (e.g., MAC addresses), or a combination of layer 2 and layer 3 data (e.g., a combination of MAC and IP addresses). The MVI 200 may include a MV modem 280, a MV signal conditioner 260, and a power line coupler 210. In addition to routing, the controller 300 may perform other functions including controlling the operation of the receiver 900, LVI 400 and MVI 200 functional components and responding to PLS commands and requests. An example of a PLCS, a BP 10, a BD 100 and associated software and circuitry that may be used in the BD 100 is provided in U.S. application Ser. No. 11/091,677, entitled “Power Line Repeater System and Method,” filed Mar. 28, 2005, which is hereby incorporated by reference in its entirety.

LV Modem

The LV modem 450 receives and transmits data over the LV power line subnet and may include additional functional submodules such as an Analog-to-Digital Converter (ADC), Digital-to-Analog Converter (DAC), a memory, source encoder/decoder, error encoder/decoder, channel encoder/decoder, MAC (Media Access Control) controller, encryption module, and decryption module. These functional submodules may be omitted in some embodiments, may be integrated into a modem integrated circuit (chip or chip set), or may be peripheral to a modem chip. In the present example embodiment, the LV modem 450 is formed, at least in part, by part number INT51X1, which is an integrated power line transceiver circuit incorporating most of the above-identified submodules, and which is manufactured by Intellon, Inc. of Ocala, Fla.

The LV modem 450 may provide decryption, source decoding, error decoding, channel decoding, and media access control (MAC) all of which are known in the art and, therefore, not explained in detail here. With respect to MAC, however, the LV modem 450 may examine information in the packet to determine whether the packet should be ignored or passed to the router 310. For example, the modem 450 may compare the destination MAC address of the incoming packet with the MAC address of the LV modem 450 (which is stored in the memory of the LV modem 450). If there is a match, the LV modem 450 may remove the MAC header of the packet and pass the packet to the router 310. If there is not a match, the packet may be ignored.

Router

The router 310 may perform prioritization, filtering, packet routing, access control, and encryption. The router 310 of this example embodiment of the present invention uses a table (e.g., a routing table) and programmed routing rules stored in memory to determine the next destination of a data packet. The table is a collection of information and may include information relating to which interface (e.g., LVI 400 or MVI 200) leads to particular groups of addresses (such as the addresses of the user devices (including control devices) connected to the customer LV power lines and other BDs 100), priorities for connections to be used, and rules for handling both routine and special cases of traffic (such as voice packets and/or control packets).

The router 310 will detect routing information, such as the destination address (e.g., the destination IP address) and/or other packet information (such as information identifying the packet as voice data), and match that routing information with rules (e.g., address rules) in the table. The rules may indicate that packets in a particular group of addresses should be transmitted in a specific direction such as through the LV power line (e.g., if the packet was received from the MV power line or receiver and the destination address corresponds to a user device (e.g., control device) connected to the LV power line), repeated on the MV line (e.g., if the BD 100 is acting as a repeater), or be ignored (e.g., if the address does not correspond to a user device connected to the LV power line or to the BD 100 itself).

As an example, the table may include information such as the IP addresses (and potentially the MAC addresses) of the user devices on the BD's LV subnet, the MAC addresses of the PLMs 50 on the BD's LV subnet, the addresses of the control devices on the LV subnet, the MV subnet mask (which may include the MAC address and/or IP address of the BD's BP 10), the IP (and/or MAC) addresses of other BDs 100 (e.g., for which the device may be repeating), and the IP address of the LV modem 450 and MV modem 280. Based on the destination address of the packet (e.g., an IP address), the router may pass the packet to the MV modem 280 for transmission on the MV power line. Alternately, if the destination address of the packet matches the address of the BD 100, the BD 100 may process the packet as a command such as request for a pay-per-view programming.

The router 310 may also prioritize transmission of packets. For example, data packets determined to be voice packets may be given higher priority for transmission through the BD 100 than data packets so as to reduce delays and improve the voice connection experienced by the user. Routing and/or prioritization may be based on IP addresses, MAC addresses, subscription level, type of data (e.g., power usage data or other enhanced power distribution system data may be given lower priority than voice or computer data), or a combination thereof (e.g., the MAC address of the PLM or IP address of the user device).

MV Modem

The MV modem 280 receives and transmits data over the MV power line. Similar to the LV modem 450, the MV modem 280 receives data from the router 310 and includes a modulator and demodulator. In addition, the MV modem 280 also may include one or more additional functional submodules such as an ADC, DAC, memory, source encoder/decoder, error encoder/decoder, channel encoder/decoder, MAC controller, encryption module, frequency conditioning module (to upband and/or downband signals) and decryption module. These functional submodules may be omitted in some embodiments, may be integrated into a modem integrated circuit (chip or chip set), or may be peripheral to a modem chip. In the present example embodiment, the MV modem 280 is formed, at least in part, by part number INT51X1, which is an integrated power line transceiver circuit incorporating most of the identified submodules and which is manufactured by Intellon, Inc. of Ocala, Fla.

The incoming data from the router 310 (or controller) is supplied to the MV modem 280, which provides MAC processing, for example, by adding a MAC header that includes the MAC address of the MV modem 280 as the source address and the MAC address of the BP 10 (and in particular, the MAC address of the MV modem of the BP) or RBD 100 as the destination MAC address. In addition, the MV modem 280 also provides channel encoding, source encoding, error encoding, and encryption. The data is then modulated and provided to the DAC to convert the digital data to an analog signal.

The term “router” is sometimes used to refer to a device that routes data at the IP layer (e.g., using IP addresses). The term “switch” or “bridge” are sometimes used to refer to a device that routes at the MAC layer (e.g., using MAC addresses). Herein, however, the terms “router”, “routing”, “routing functions” and the like are meant to include both routing at the IP layer and MAC layer. Consequently, the router 310 of the present invention may use MAC addresses instead of, or in addition to, IP addresses to perform routing functions.

Signal Conditioners

The signal conditioners 420 and 260 may provide filtering (anti-alias, noise, and/or band pass filtering) and amplification. In addition, the signal conditioners may provide frequency translation.

MV Power Coupler Line

The coupling device 210 may be inductive, capacitive, conductive, a combination thereof, or any suitable device for communicating data signals to and/or from the MV power line.

Controller

As discussed, the controller 300 includes the hardware and software for managing communications and control of the BD 100. In this embodiment, the controller 300 includes an IDT 32334 RISC microprocessor for running the embedded application software and also includes flash memory for storing the boot code, device data and configuration information (serial number, MAC addresses, subnet mask, and other information), the application software, routing table, and the statistical and measured data. This memory includes the program code stored therein for operating the processor to perform the routing functions described herein.

This embodiment of the controller also includes random access memory (RAM) for running the application software and temporary storage of data and data packets. This embodiment of the controller 300 also includes an Analog-to-Digital Converter (ADC) for taking various measurements, which may include measuring the temperature inside the BD 100 (through a temperature sensor such as a varistor or thermistor), for taking power quality measurements, detecting power outages, measuring the outputs of feedback devices, and others. The embodiment also includes a “watchdog” timer for resetting the device should a hardware glitch or software problem prevent proper operation to continue.

This embodiment of the controller 300 also includes an Ethernet adapter, an optional on-board MAC and physical (PHY) layer Ethernet chipset that can be used for converting peripheral component interconnect (PCI) to Ethernet signals for communicating with the backhaul side of the BD 100. Thus, the RJ45 connector may provide a port for a wireless transceiver (which may be a 802.11 compliant transceiver) for communicating wirelessly to the BP 10 or other BD 100, which, of course, would include a similar transceiver.

In addition to storing a real-time operating system, the memory of controller 300 of the BD 100 also includes various program code sections such as a receiver control software, software upgrade handler, software upgrade processing software, the PLS command processing software (which receives commands from the PLS, and processes the commands, and may return a status back to the PLS), the ADC control software, the power quality monitoring software, the error detection and alarm processing software, the data filtering software, the traffic monitoring software, the network element provisioning software, and a dynamic host configuration protocol (DHCP) Server for auto-provisioning user devices (e.g., user computers) and associated PLMs.

### Alternate Embodiments

In an alternate embodiment, a receiver may be located at the customer premises and connected to a PLM instead of being disposed at the distribution transformer and/or in the BD. In this embodiment, analog broadcast data may digitized and transmitted over the LV power line or other medium for reception by an A/D converter, which supplies the analog signal to the receiver. Thus, the user may not need a separate control device. In any of the embodiment describer herein, multiple antennas and/or multiple receivers may form part of or be connected to the power line communication device (e.g., BD).

As discussed, the BD 100 of the above embodiment communicates data signals including satellite broadcast data to user devices via the LV power lines. Rather than communicating data signals to the PLM 50 and/or user devices via the LV power line, the BD 100 may use other communication media. For example, the BD may convert the data signals to a format for communication via a telephone line (e.g., DSL signals), fiber optic, RF cable, or coaxial cable. Such communication may be implemented in a similar fashion to the communication with LV power line, as would be well known to those skilled in the art.

In addition, the BD 100 may communicate wireless signals over a wireless communication link to the user device(s). In this case, the user device may be coupled to a wireless transceiver for communicating through the wireless communication link. The wireless communication link may be a wireless link implementing a network protocol in accordance with an IEEE 802.11 (e.g., a, b, or g) standard.

Alternatively, the BD 100 may communicate with the user device via fiber optic link. In this alternative embodiment, the BD 100 may convert the data signals to light signals for communication over the fiber optic link. In this embodiment, the customer premises may have a fiber optic cable for carrying data signals, rather than using the internal wiring of customer premise.

In another embodiment of the present invention the BD 100 may be linked to the customer premises via a coaxial cable. The coaxial cable may be connected to the BD 100 on its first end and to the low voltage power line on its second end via a power line/coaxial coupler (PLCC) at the customer premises. The PLCC may be comprised of a pair of high pass filters that permit the higher frequency data signals to couple between the coaxial cable and the power line, but prevent the lower frequency power signals from coupling therebetween. The first high pass filter may couple the concentric conductor of the coaxial cable to the neutral LV conductor and the second filter may couple the center conductor of the coaxial cable to the first energized LV conductor. The PLCC may make the connection to the LV power line by being plugged into an external outlet or be integrated into an external outlet (e.g., and having a coaxial connector exposed externally for connection). The PLCC also may include impedance matching and transient suppression circuits. Alternately, the PLCC may be integrated into the power meter (e.g., which may have the coaxial connector exposed) in which case the first filter of the PLCC may be coupled to the second energized LV conductor (e.g., instead of the neutral) to differentially transmit the data signals on the two LV energized conductors.

In another embodiment of the present invention, the BD may further include an IEEE 802.11 a, b, or g transceiver (in addition to the LVI) and broadcast the broadcast data to customer premises for reception by a broadcast receiver coupled to a wireless receiver. This broadcast may be encrypted and/or addressed so that only subscribers of the broadcast service can receive and view the presentation or it may be a promotional broadcast so that anyone with a suitable Wifi receiver (IEEE 802.11 receiver) can receive and view the broadcast. The BD may also provide an internet connection via the power lines simultaneously with the broadcast data wireless transmission.

In an alternate embodiment, the PLCC may include a first modem and a power line modem (e.g., a power line modem chip set) communicatively coupled together. The first modem may provide communications with the BD 100 and the PLM may provide communications for the other PLMs in the customer premises that are coupled to the internal electrical wiring. The communications with the BD 100 may be OFDM (wherein the first modem may be a power line modem chip set) or DOCSIS (wherein the first modem may be a cable modem). In other embodiments, instead of a coaxial cable link between the BD 100 and the customer premises, the link may be a twisted pair, Ethernet, optical fiber or wireless. In still another embodiment, the BD 100 may not be connected to the internal LV power line network but instead may be connected to a customer premises wireless network (e.g., 802.11), the internal twisted pair telephone network, or the internal coaxial cable network.

Furthermore, if significant bandwidth is needed, communications for user devices in a single home may use both the power line and non-power line medium. For example, high definition television data (broadcast data) may be transmitted via the coaxial cable (which may also be connected to the internal coaxial cable network of the home instead of the LV power lines) and Internet traffic may be communicated via the low voltage power lines. Thus, the BD 100 may prioritize and route data traffic to the appropriate access link according to the data type (e.g., voice, Internet radio, video, image, Internet (HTML), broadcast data, and video gaming data), packet size (e.g., giving smaller packets lower or higher priority), and/or transmitting device (e.g., telephone device given higher priority).

In another embodiment, the PLCS may be used by the subscriber as a backup service to a cable Internet service provider (ISP), wireless ISP, or a DSL ISP. Thus, the BD 100 may be coupled to a switch in the customer premises. The switch may be a three port device with one port connected to the user device (e.g., a computer), a second port connected to the alternate ISP system and the third port connected to the PLCS (i.e., the BD 100). If the alternate ISP fails, or becomes slowed (e.g., due to high data traffic), the switch can be actuated to switch user device to be connected to the PLCS. Thus, the user device (e.g., computer), or the PLM, may include software for detecting a failed connection and/or a slowed connection, and for automatically actuating a switch to change to a different broadband provider upon detection. Alternately, the user device may be coupled to both the PLCS and the alternate ISP to increase bandwidth for the user, which may require a router at the customer premises. The alternate ISP may be used for some types of traffic (e.g., voice) and the PLCS may be used for other types of data types (e.g., Internet, HDTV).

Miscellaneous

While the above embodiments of the BD 100 have been described as being communicatively coupled to a single LV subnet, other embodiments may be connected to multiple LV subnets. For example, the BD 100 may have two LV interfaces, with each LV interface being connected to a different LV subnet. Alternately, the BD 100 may have a single LV interface with two sets of connecting conductors and with each connecting conductor have a high pass filter in series with the connecting conductor (to isolate the power signals from the respective LV subnets). Alternately, two BDs 100 may be installed at one utility pole, but share a signal MV coupler that is connected to a “Y” connector, or splitter, which feeds the two BDs 100. Each BD 100, however, may be connected to separate LV subnets.

In the above embodiment, the processor performs routing functions and may act as a router in some instances and perform other functions at other times depending on the software that is presently being executed. The router may also be a chip, chip set, or circuit board (e.g., such as an off the shelf circuit card) specifically designed for routing, any of which may include memory for storing, for example, routing information (e.g., the routing table) including MAC addresses, IP addresses, and address rules.

Finally, the type of data signal may be any suitable type of data signal. The type of signal modulation used can be any suitable signal modulation used in communications (Code Division Multiple Access (CDMA), Time Division Multiple Access (TDMA), Frequency Division Multiplex (FDM), Orthogonal Frequency Division Multiplex (OFDM), and the like). OFDM may be used for one or both of the LV and MV power lines. A modulation scheme producing a wideband signal such as CDMA or OFDM that is relatively flat in the spectral domain may be used to reduce radiated interference to other systems while still delivering high data communication rates.

In addition, instead of using OFDM signals on the MV power line or LV power line, an alternate embodiment of a PLCS system may use ultra wideband signals or surface wave signals (Goubau waves) to provide communications over the MV and/or LV power lines. In another embodiment, instead of using the MV power lines, the signals, which may be OFDM, UWB, surface waves signals, or another type of signal, may be transmitted on the neutral conductor(s) that span from transformer to transformer. Use of the neutral conductor may reduce the need to isolate from the high voltage of the MV power line and thereby reduce the cost of installation and of the coupler.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A communication system for communicating data via an external low voltage power line subnet, comprising:
a first modem configured to provide communications for a user device;
a second modem configured to be communicatively coupled to a medium voltage power line,
an antenna;
a receiver configured to receive a broadcast signal via said antenna; and
a processor in communication with said first modem, said second modem, and said receiver.

2. The system of claim 1, wherein said antenna comprises a satellite dish antenna.

3. The system of claim 1, wherein said a receiver is configured to demodulate the broadcast signal.

4. The system of claim 1, wherein said receiver includes a first tuner configured to extract a first digital data stream from the broadcast signal.

5. The system of claim 4, wherein said receiver includes a second tuner configured to extract a second digital data stream from the broadcast signal.

6. The system of claim 1, wherein the user device comprises a first presentation device disposed in a first customer premises.

7. The system of claim 6, wherein said first modem is configured to communicate with a second presentation device disposed in a second customer premises.

8. The system of claim 6, wherein said first modem is configured to communicate with the first presentation device via a control device disposed at the first customer premises.

9. The system of claim 8, wherein said control device is configured to provide a National TV Standards Committee (NTSC) signal to the first presentation device.

10. The system of claim 8, wherein said control device is configured to provide a high definition television signal to the first presentation device.

11. The system of claim 8, wherein said control device is configured to transmit a request for programming to said first modem in response to a user input.

12. The system of claim 1, wherein said first modem is configured to communicate with one or more user devices via a wireless link.

13. The system of claim 1, further comprising a router in communication with said first modem and said second modem.

14. The system of claim 13, further comprising a computer readable medium encoded with executable instructions to cause said processor to function as said router.

15. The system of claim 1, wherein said first modem, said processor, and said second modem are disposed in a housing and said housing is mounted on a utility pole.

16. The system of claim 15, wherein said receiver is disposed in said housing.

17. The system of claim 1, wherein said receiver is responsive to user requests received via said first modem to provide selected programming data received via said antenna to the customer premises of the user via said first modem.

18. The system of claim 17, further comprising a computer readable medium encoded with executable instructions to cause said processor to cause said first modem to transmit said selected programming data.

19. The system of claim 1, wherein said antenna is configured to receive terrestrial broadcast signals.

20. The system of claim 1, further comprising a computer readable medium encoded with executable instructions to cause said processor to respond to commands received by said second modem via the medium voltage power line.

21. The system of claim 20, wherein a first command comprises a command to enable a broadcast signal subscription of a user.

22. The system of claim 1, wherein said antenna comprises a satellite dish configured to transmit signals to at least one satellite.

26. The system of claim 1, wherein said first modem is configured to communicate with a user device through a coaxial cable.

27. The system of claim 1, wherein said first modem is configured to communicate with a plurality of user devices through the low voltage power line subnet.

28. The system of claim 1, wherein said receiver is configured to provide broadcast data to said processor; and further comprising:
a computer readable medium encoded with executable instructions to cause said processor to extract a first digital data stream from said broadcast data and to cause said first modem to transmit said first digital data stream.

29. The system of claim, 13, wherein said router is further in communication with said receiver and is configured to route data received from said second modem and said receiver to said first modem.

30. A system for communicating data over a low voltage power line, comprising:
an antenna;
a receiver configured to receive a broadcast signal via said antenna;
a modem configured to communicate with a plurality of user devices via the low voltage power line; and
a processor in communication with said modem and said receiver.

31. The system of claim 30, wherein said receiver includes a first tuner configured to extract a first digital data stream from the broadcast signal.

32. The system of claim 31, wherein said receiver includes a second tuner configured to extract a second digital data stream from the broadcast signal.

33. The system of claim 30, wherein said first modem is configured to communicate with a first presentation device via a control device disposed at a first customer premises.

34. The system of claim 33, wherein said control device is configured to transmit a high definition television signal to the first presentation device.

35. The system of claim 33, wherein said control device is configured to transmit a request for programming to said first modem in response to a user input.

36. The device of claim 30, wherein said receiver is responsive to user requests received via said first modem to provide selected programming data received via said antenna to the customer premises of the user via said first modem.

37. A method of providing communications to one or more user devices via a low voltage power line, comprising:
receiving first data via an antenna;
receiving second data via a medium voltage power line;
routing the first data and the second data to a modem;
transmitting the first data over a low voltage power line with the modem; and
transmitting the second data over the low voltage power line with the modem.
